(19) United States
(12) Patent Application Publication
(10) Pub. No.: US 2016/0018068 A1
(43) Pub. Date: Jan. 21, 2016

(54) OPTICAL MODULE

(71) Applicant: PlayNitride Inc., Tainan City (TW)

(72) Inventors: Sheng-Yuan Sun, Tainan City (TW); Po-Jen Su, Tainan City (TW); Kuan-Yung Liao, Tainan City (TW); Gwo-Jiun Sheu, Tainan City (TW)

(21) Appl. No.: 14/737,497

(22) Filed: Jun. 12, 2015

(30) Foreign Application Priority Data
Jul. 16, 2014 (TW) 103124430

(51) Int. Cl. F21K 99/00; F21V 9/16; F21V 5/04; F21V 13/14; F21V 7/06; F21V 7/08

(52) U.S. Cl. CPC F21K 9/56; F21K 9/10; F21V 7/06; F21V 7/08; F21V 5/045; F21V 5/048; F21V 13/14; F21V 9/16; F21Y 2101/025

(57) ABSTRACT

An optical module including at least one light source, a wavelength conversion member and a concave reflector is provided. Light emitted from the at least one light source enters the wavelength conversion member and then is sent out toward all directions. The concave reflector is disposed at one side of the wavelength conversion member, and a part of the light sent from the wavelength conversion member is reflected by the concave reflector.

### CROSS-REFERENCE TO RELATED APPLICATION

This application claims the priority benefit of Taiwan application serial no. 103124430, filed on Jul. 16, 2014. The entirety of the above-mentioned patent application is hereby incorporated by reference herein and made a part of this specification.

### FIELD OF THE INVENTION

The invention relates to an optical module.

### DESCRIPTION OF RELATED ART

Nowadays, it is very common to provide illumination or specific optical effects through an optical module in a specific design. Take a flash lamp as an example, when there is insufficient light, fill light effects of the flash lamp may be utilized for compensating insufficient light in an environment. However, a light source of the conventional flash lamp emits lights through a quartz tube filled with a high pressure inert gas, xenon gas and containing mercury and carbon compounds, and stimulates xenon gas with a stabilizer having 23,000 volts of high-voltage currents, such that a white electric arc is generated between the two electrodes. Since structures such as tubes and electrodes are required, the light source of the conventional flash lamp contains a certain size of a volume which affects a size of the flash lamp. In addition, as far as a small-sized flash lamp, a vehicle light or a torch is concerned, an effective distance of light emitted from such optical module is only about one meter, which may only be used for fill light or illumination effects in a short-range distance, while fill light or illumination effects cannot be provided for a long-range distance.

### SUMMARY OF THE INVENTION

The invention provides an optical module in a smaller size, in which a large-sized quartz tube is replaced by a point light source in collocation with a small-sized wavelength conversion member in a spherical shape, a block shape or a thin strip shape, so as to form a light source similar to the point light source or a linear light source.

An optical module of the invention includes at least one light source, a wavelength conversion member, and a concave reflector. Light emitted from the light source enters the wavelength conversion member and then is sent out toward all directions from the wavelength conversion member. The concave reflector is disposed at one side of the wavelength conversion member, wherein a part of the light sent from the wavelength conversion member is reflected by the concave reflector.

In an embodiment of the invention, the wavelength conversion member is located on a focal point of the concave reflector.

In an embodiment of the invention, the wavelength conversion member is in a spherical shape or a block shape.

In an embodiment of the invention, a dimensional ratio of the wavelength conversion member to the concave reflector ranges approximately from 0.1 to 0.6.

In an embodiment of the invention, the wavelength conversion member is in a strip shape. The at least one light source is two light sources, and the two light sources are disposed at two sides of the wavelength conversion member, respectively.

In an embodiment of the invention, the light source is a laser light source.

In an embodiment of the invention, a concave profile of the concave reflector is a paraboloid or a partial ellipse.

In an embodiment of the invention, a reflector is further included, wherein a light emitted from a light source is reflected to a wavelength conversion member by the reflector.

In an embodiment of the invention, a lens is further included. The lens and a concave reflector are disposed at two different sides of a wavelength conversion member, respectively.

In an embodiment of the invention, the lens is a convex lens. A wavelength conversion member is located on a focal point of a concave reflector, and is located inside a focal point of the lens.

In an embodiment of the invention, the lens is a convex lens. A wavelength conversion member is located inside a focal point of a concave reflector, and is located on a focal point of the lens.

In an embodiment of the invention, the lens is a concave lens. A wavelength conversion member is located on a focal point of a concave reflector, and is located outside a focal point of the lens.

In an embodiment of the invention, the lens is a concave lens. A wavelength conversion member is located inside a focal point of a concave reflector, and is located on a focal point of the lens.

In an embodiment of the invention, the lens is a Fresnel lens.

In light of the foregoing, the optical module of the invention is in a smaller size, in which a large-sized quartz tube is replaced by a point light source in collocation with a small-sized wavelength conversion member in a spherical shape, a block shape or a thin strip shape, so as to form a light source similar to the point light source or a linear light source. In addition, at least a part of light emitted from a light source passes through the wavelength conversion member and then is sent out toward all directions. A part of the light passing through the wavelength conversion member is sent out toward a concave reflector and is reflected forward by the concave reflector. Other parts of the light are sent out toward other directions so as to provide fill light effects with a large angle. Furthermore, if the wavelength conversion member is disposed on a focal point of the concave reflector, the light sent out toward the concave reflector becomes parallel lights by reflections so as to form a high beam, and the parts of the light passing through the wavelength conversion member are sent out toward other directions so as to form a low beam, such that the optical module of the invention is capable of emitting the high beam and the low beam at the same time. If the wavelength conversion member is applied to a flash lamp, the needs for long-range and close-range fill light are satisfied at the same time. Moreover, in the optical module of the invention, a lens may also be disposed at one side of the wavelength conversion member far away from the concave reflector. If the lens is a convex lens and the wavelength conversion member is located inside a focal point of the lens, the light passing through the lens may be further dispersed to form a more uniformed low beam. Certainly, a manufacturer may select various kind of lenses, and accordingly adjust a distance between the wavelength conversion member and the concave reflector and a distance between the wavelength conversion member and the lens, such that the light reflected by the concave reflector and the light passing through the lens are changed to become a high beam or a low beam.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a side view illustrating an optical module according to an embodiment of the invention.

FIG. 1B is a top view illustrating a light source and a wavelength conversion member of the optical module depicted in FIG. 1A.

FIG. 2A is a side view illustrating an optical module according to another embodiment of the invention.

FIG. 2B is a top view illustrating a light source and a wavelength conversion member of the optical module depicted in FIG. 2A.

FIG. 3 is a side view illustrating an optical module according to another embodiment of the invention.

FIG. 4 to FIG. 7 are side views illustrating multiple optical modules according to other embodiments of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

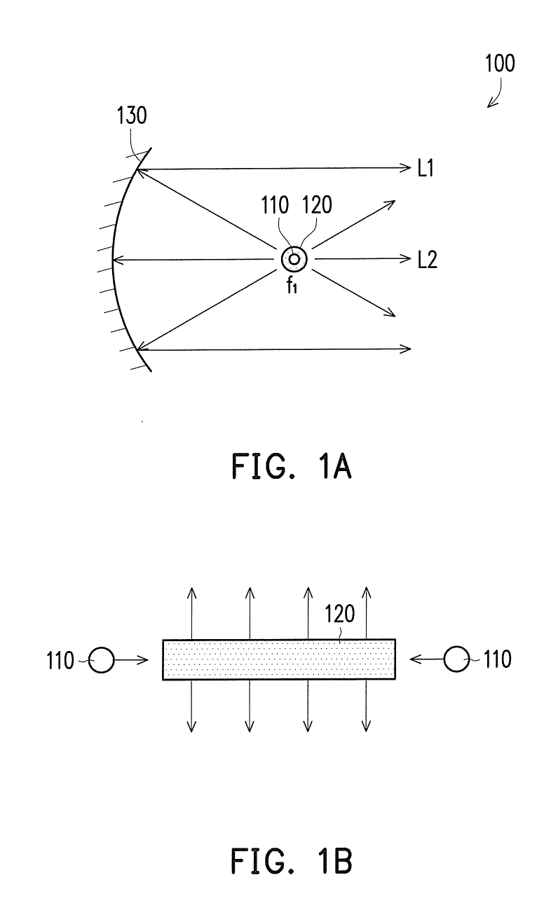

FIG. 1A is a side view illustrating an optical module according to an embodiment of the invention. With reference to FIG. 1A, an optical module 100 of the present embodiment includes at least one light source 110, a wavelength conversion member 120, and a concave reflector 130. In the present embodiment, the light source 110 is exemplified by a laser light source, which may provide sufficient energy, but varieties of the light source 110 are not limited herein. In other embodiments, light emitting diodes (LEDs) and so on may also be selected to be the light source 110. In the present embodiment, the optical module 100 is exemplified by being applied to a flash lamp, but in other embodiments, the optical module 100 may also be applied to a vehicle light or a torch, etc. The varieties of the optical module 100 are not limited herein.

FIG. 1B is a top view illustrating a light source and a wavelength conversion member of the optical module depicted in FIG. 1A. With reference to 1B, in the present embodiment, the wavelength conversion member 120 is in a strip shape, and numbers of the light source are two. The two light sources 110 are disposed at two sides of the strip-shaped wavelength conversion member 120, respectively, and emit lights from the two sides into the wavelength conversion member 120. The wavelength conversion member 120 is configured for converting wavelengths of the lights emitted from the light source 110 into wavelengths of other lights. For example, the light emitted from the light source 110, for example, is a blue light, and the wavelength conversion member 120, for example, converts the blue light into a yellow light. Accordingly, the yellow light emitted from the wavelength conversion member 120 and the blue light not converted by the wavelength conversion member 120 are mixed to form a white light. However, the invention herein does not limit wavelengths of lights emitted from the light source 110 and varieties of wavelengths converted by the wavelength conversion member 120.

In the present embodiment, a fluorescent block having a mono-crystalline structure may be selected to be used as the wavelength conversion member 120, and the fluorescent block is then polished into a desired form. However, in other embodiments, the wavelength conversion member 120 may also be formed by solidifying a transparent gel mixed with a phosphor powder material, a phosphorescent material, or dyes. As far as the transparent gel mixed with the phosphor powder material is concerned, the transparent gel may be epoxy resin, acrylic resin, silicone resin or silica gel. The transparent gel may be mixed with single colored or multicolored phosphor powder materials. For example, a yellow phosphor powder material or a green phosphor powder material includes components such as Sr, Ga, S, P, Si, O, Gd, Ce, Lu, Ba, Ca, N, Si, Eu, Y, Cd, Zn, Se, and Al. For example, the phosphor powder may be garnet phosphor, silicate phosphor, nitrogen compound phosphor, or oxide-nitride compound phosphor. The phosphor powder may also be yttrium aluminum garnet (YAG) phosphor, terbium aluminum garnet (TAG) phosphor, eu-activated alkaline earth silicate phosphor, or sialon phosphor. In another embodiment, the wavelength conversion member 120 may also be formed into a block by sintering laminated polycrystalline powder containing phosphor powder. Certainly, varieties of the wavelength conversion member 120 in the above embodiments are not limited thereto.

After the light emitted from the light source 110 enters the wavelength conversion member 120, the light may be sent out toward all directions from the strip-shaped wavelength conversion member 120. According to an angle of view in FIG. 1A, the light passing through the wavelength conversion member 120 is sent out toward all directions of a planar depicted in FIG. 1A. The concave reflector 130 is disposed at one side of the wavelength conversion member 120. Accordingly, a part of the light sent from the wavelength conversion member 120 is reflected by the concave reflector 130. In the present embodiment, a concave profile of the concave reflector 130 is a paraboloid, and the wavelength conversion member 120 is located on a focal point f1 of the concave reflector 130, such that a light L1 reflected by the concave reflector 130 may be sent out in a form of parallel lights to form a high beam. A light L2 not reflected by the concave reflector 130 is formed to be a low beam. That is to say, the optical module 100 of the present embodiment may emit the high beam and the low beam at the same time, and is capable of satisfying close-range and long-range shootings at the same time.

Of course, a location of the wavelength conversion member 120 with respect to the concave reflector 130 is not limited herein. In other embodiments, even if the wavelength conversion member 120 is not located on the focal point f1 of the concave reflector 130, a part of the light sent from the wavelength conversion member 120 would still be reflected toward the right direction of FIG. 1A by the concave reflector 130. Compared to the lights not reflected by the concave reflector 130, the light reflected by the concave reflector 130 is capable of providing more diversified angles, such that the optical module 100 may achieve fill light effects with a larger angle.

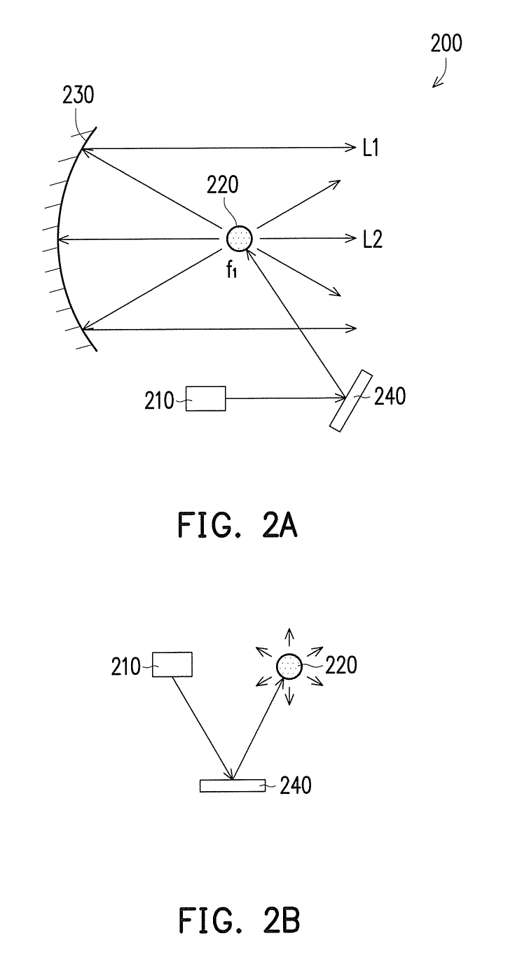

FIG. 2A is a side view illustrating an optical module according to another embodiment of the invention. With reference to FIG. 2A, one of differences between an optical module 200 depicted in FIG. 2A and the optical module 100 depicted in FIG. 1A lies in a location of a light source 210. In FIG. 1A, the light source 110 is located beside the wavelength conversion member 120, and the light emitted from the light source 110 directly enters the wavelength conversion member 120. In FIG. 2A, the light source 210 is located at a position farther away from a wavelength conversion member 220, and the light source 210 does not directly enter the wavelength conversion member 220. Accordingly, in the present embodiment, the optical module 200 further includes a reflector 240. The reflector 240 is located at a light path of a light emitted from the light source 210, such that the light emitted from the light source 210 is able to be reflected by the reflector 240, and the reflected light enters the wavelength conversion member 220.

FIG. 2B is a top view illustrating a light source and a wavelength conversion member of the optical module depicted in FIG. 2A. With reference to FIG. 2B, another difference between the optical module 200 of the present embodiment and the optical module 100 of the previous embodiment lies in a shape of the wavelength conversion member 220. In the previous embodiment the wavelength conversion member 120 is in a strip shape, and the light emitted from the wavelength conversion member 120 is sent out toward all directions in a form which is similar to a linear light source. In the present embodiment, the wavelength conversion member 220 is in a small-sized spherical shape or a block shape, and the light emitted from the wavelength conversion member 220 may be sent out toward all directions in a form which is similar to a small point.

In the present embodiment, a dimensional ratio of the wavelength conversion member 220 to a concave reflector 230 ranges approximately from 0.1 to 0.6. Whether a luminous body, composed of the light sources 110 and 210 accompanied with the wavelength conversion members 120 and 220, emits light in a form of a point light source or the linear light source, varieties of the optical modules 100 and 200 are exemplified by flash lamps which has a smaller size compared to conventional flash lamps utilizing quartz tubes or quartz lamp bulbs. Thereby, sizes of the optical modules 100 and 200 may further be reduced. Of course, the above only provides several shapes and sizes of the wavelength conversion members 120 and 220. However, the shapes and sizes of the wavelength conversion members 120 and 220 as well as the dimensional ratio of the wavelength conversion members 120 and 220 to the concave reflectors 130 and 230 are not limited thereto.

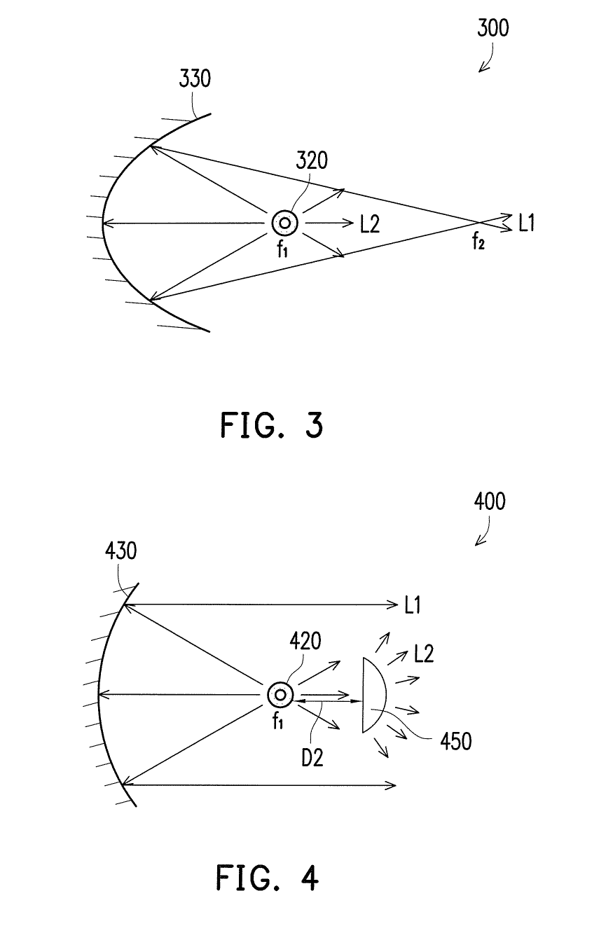

FIG. 3 is a side view illustrating an optical module according to another embodiment of the invention. With reference to FIG. 3, a primary difference between an optical module 300 depicted in FIG. 3 and the optical module 100 depicted in FIG. 1A lies in that a concave profile of the concave reflector 130 depicted in FIG. 1A is a paraboloid, while a concave profile of a concave reflector 330 depicted in FIG. 3 is a partial ellipse. In the present embodiment, a wavelength conversion member 320 is arranged on one of the elliptic focal points f1. After a part of a light passing through the wavelength conversion member 320 is reflected by the concave reflector 330, the light L1 is converged on another elliptic focal point f2 rather than being sent out as a parallel light. In other words, if a user requires the optical module 300 that gathers parts of a light on a specific location and presents parts of the light L2 in a form of a low beam, then the optical module 300 in this type may be adopted for use.

FIG. 4 to FIG. 7 are side views illustrating multiple optical modules according to other embodiments of the invention. With reference to FIG. 4, a primary difference between an optical module 400 depicted in FIG. 4 and the optical module 100 depicted in FIG. 1A lies in that the optical module 400 depicted in FIG. 4 further includes a lens 450. The lens 450 and a concave reflector 430 are disposed at two different sides of a wavelength conversion member 420, respectively. The lens 450 of the present embodiment is a convex lens. The wavelength conversion member 420 is located on the focal point f1 of the concave reflector 430, and inside a focal point of the lens 450. In other words, a distance D2 from the wavelength conversion member 420 to the lens 450 is shorter than a focal length of the lens 450. The wavelength conversion member 420 is located on the focal point f1 of the concave reflector 430, such that the light L1 reflected by the concave reflector 430 is sent out in a form of the parallel light so as to form the high beam. A part of a light passing through the wavelength conversion member 420 passes through the lens 450. Since the wavelength conversion member 420 is located inside a focal point of a convex lens, the light L2 passing through the lens 450 may be dispersed in a more uniformed way so as to form a low beam, and effects of better high beam and low beam are provided to meet demands.

Certainly, a manufacturer may select the lens 450 in various kinds based on requirements, and accordingly adjust a distance between the wavelength conversion member 420 and the concave reflector 430 and a distance between the wavelength conversion member 420 and the lens 450, so as to change the light reflected by the concave reflector 430 and the light passing the lens 450 into the high beam or the low beam. The following further describes the above.

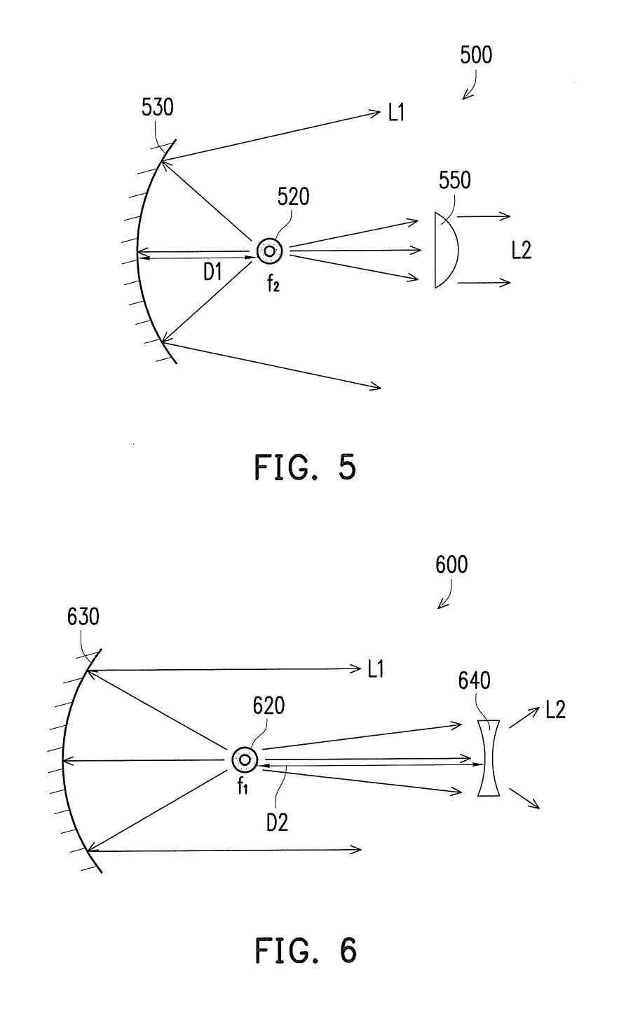

With reference to FIG. 5, a primary difference between an optical module 500 depicted in FIG. 5 and the optical module 400 depicted in FIG. 4 lies in relative positions of a wavelength conversion member 520 and a concave reflector 530 as well as relative positions of the wavelength conversion member 520 and a lens 550. In the present embodiment, the wavelength conversion member 520 is located inside a focal point of the lens 530, and on the focal point f2 of the lens 550. In other words, a distance D1 from the wavelength conversion member 520 to the concave reflector 530 is shorter than a focal length of the lens 530. Since the wavelength conversion member 520 is located inside a focal point of the concave reflector 530, the light L1 reflected by the concave reflector 530 is dispersed to form a low beam. In addition, a part of a light passing through the wavelength conversion member 520 passes through the lens 550. Since the wavelength conversion member 520 is located on the focal point f2 of the convex lens 550, the light L2 passing through the lens 550 may be sent out in a form of a parallel light so as to form a high beam. In other words, as long as a position of the wavelength conversion member 520 with respect to the concave reflector 530 and the lens 550 is to be changed, the light reflected by the concave reflector 530 and the light passing through the lens 550 may be adjusted so as to emit the high beam or the low beam.

With reference to FIG. 6, a primary difference between an optical module 600 depicted in FIG. 6 and the optical module 400 depicted in FIG. 4 lies in that a lens 640 of the present embodiment is a concave lens. The wavelength conversion member 620 is located on the focal point f1 of a concave reflector 630, and outside a focal point of the lens 640. In other words, the distance D2 from the wavelength conversion member 620 to the lens 640 is longer than a focal length of the lens 640. The wavelength conversion member 620 is located on the focal point f1 of the concave reflector 630, such that the light L1 reflected by the concave reflector 630 is sent out in a form of a parallel light so as to form a high beam. A part of a light passing through the wavelength conversion member 620 passes through the lens 650. Since the wavelength conversion member 620 is located outside a focal point of the lens 640, the light L2 passing through the lens 640 is dispersed to form a low beam.

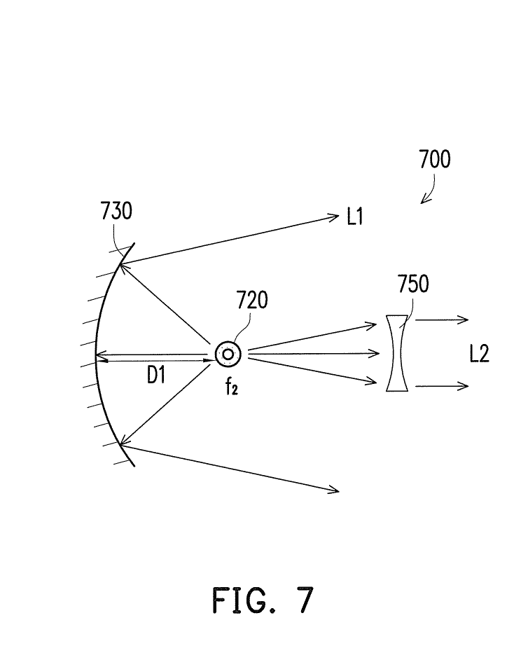

With reference to FIG. 7, a primary difference between an optical module 700 depicted in FIG. 7 and the optical module 600 depicted in FIG. 6 lies in relative positions of a wavelength conversion member 720 and a concave reflector 730 as well as relative positions of the wavelength conversion member 720 and a lens 750. In the present embodiment, the wavelength conversion member 720 is located inside a focal point of the concave reflector 730. In other words, the distance D1 from the wavelength conversion member 720 to the concave reflector 730 is shorter than a focal length of the concave reflector 730, such that the light L1 reflected by the concave reflector 730 is dispersed to form a low beam. In addition, a part of a light passing through the wavelength conversion member 720 passes through the lens 750. Since the wavelength conversion member 720 is located on the focal point f2 of the lens 750, the light L2 passing through the lens 750 may be sent out in a form of a parallel light to form a high beam.

Several examples are described above to illustrate high and low beams which are formed by coordinating the concave reflectors 430, 530, 630 and 730 with the lenses 450, 550, 640 and 750. Of course, varieties of the lenses 450, 550, 640 and 750, relative positions of the wavelength conversion members 420, 520, 620 and 720 and the concave reflectors 430, 530, 630 an 730 as well as relative positions of the wavelength conversion members 420, 520, 620 and 720 and the lenses 450, 550, 640 and 750 are not limited thereto. In other embodiments, a light may be dispersed or converged based on requirements by substituting other components for the lenses 450, 550, 640 and 750 or the concave reflectors 430, 530, 630 and 730 in an optical module.

It should be noted that the lenses 450, 550, 640 and 750 illustrated in FIG. 4 to FIG. 7 are traditional spherical lenses. However, in an embodiment not illustrated herein, the lenses 450, 550, 640 and 750 may also be Fresnel lenses. Compared to the traditional spherical lens, the Fresnel lens is capable of achieving the optical effect approximate to that of traditional spherical lens and is thinner in thickness, and may reduce a size of an optical module.

In summary, the optical module of the invention is provided in a smaller size, in which a large-sized quartz tube is replaced by a point light source in collocation with a small-sized wavelength conversion member in a spherical shape, a block shape or a thin strip shape, so as to form a light source similar to the point light source or a linear light source. In addition, at least a part of a light emitted from a light source is sent out toward all directions after passing through the wavelength conversion member. A part of the light passing through the wavelength conversion member is sent out toward a concave reflector and reflected forward by the concave reflector. Parts of the light are sent out toward other directions so as to provide fill light effects with a large angle. Furthermore, if the wavelength conversion member is disposed on a focal point of the concave reflector, the light sent out to the concave reflector is reflected to become parallel lights so as to form a high beam, and the parts of the light passing through the wavelength conversion member are sent out toward other directions so as to form a low beam, such that the optical module of the invention is capable of emitting the high beam and the low beam at the same time. If the wavelength conversion member is applied on a flash lamp, the needs for long-range and close-range fill lights are satisfied. Moreover, the optical module of the invention may further be provided with a lens which is disposed at one side of the wavelength conversion member far away from the concave reflector. If the lens is a convex lens and the wavelength conversion member is located inside a focal point of the lens, the light passing through the lens may be further dispersed so as to form a more uniformed low beam. Certainly, a manufacturer may select a lens in various kinds, and accordingly adjust a distance between the wavelength conversion member and the concave reflector and a distance between the wavelength conversion member and the lens, such that the light reflected by the concave reflector and the light passing through the lens are changed to become a high beam or a low beam.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An optical module, comprising:
at least one light source;
a wavelength conversion member, wherein light emitted from the at least one light source enters the wavelength conversion member, and is sent out toward all directions; and
a concave reflector disposed at one side of the wavelength conversion member, wherein a part of the light sent from the wavelength conversion member is reflected by the concave reflector.

2. The optical module as claimed in claim 1, wherein the wavelength conversion member is located on a focal point of the concave reflector.

3. The optical module as claimed in claim 1, wherein the wavelength conversion member is in a spherical shape or a block shape.

4. The optical module as claimed in claim 1, wherein a dimensional ratio of the wavelength conversion member to the concave reflector ranges approximately from 0.1 to 0.6.

5. The optical module as claimed in claim 1, wherein the wavelength conversion member is in a strip shape, the at least one light source is two light sources, the two light sources are disposed at two sides of the wavelength conversion member, respectively.

6. The optical module as claimed in claim 1, wherein the at least one light source is a laser light source.

7. The optical module as claimed in claim 1, wherein a concave profile of the concave reflector is a paraboloid or a partial ellipse.

8. The optical module as claimed in claim 1, further comprising:
a reflector, wherein the light emitted from the at least one light source is reflected to the wavelength conversion member by the reflector.

9. The optical module as claimed in claim 1, further comprising:
a lens, the lens and the concave reflector disposed at two different sides of the wavelength conversion member, respectively.

10. The optical module as claimed in claim 9, wherein the lens is a convex lens, the wavelength conversion member is located on a focal point of the concave reflector, and is located inside a focal point of the lens.

11. The optical module as claimed in claim 9, wherein the lens is a convex lens, the wavelength conversion member is located inside a focal point of the concave reflector, and is located on a focal point of the lens.

12. The optical module as claimed in claim 9, wherein the lens is a concave lens, the wavelength conversion member is located on a focal point of the concave reflector, and is located outside a focal point of the lens.

13. The optical module as claimed in claim 9, wherein the lens is a concave lens, the wavelength conversion member is located inside a focal point of the concave reflector, and is located on a focal point of the lens.

14. The optical module as claimed in claim 9, wherein the lens is a Fresnel lens.
